(19) United States
(12) Patent Application Publication
(10) Pub. No.: US 2021/0295409 A1
(43) Pub. Date: Sep. 23, 2021

(54) UNIFIED ALTERNATIVE ITEM SELECTION USER EXPERIENCE

(71) Applicant: Amazon Technologies, Inc., Seattle, WA (US)

(72) Inventors: Jason Rudmann, Spokane, WA (US); Tony Hon Kit Li, Brisbane (AU); Damien Fitzpatrick, Annerley (AU); Donald Christopher Woods, Seattle, WA (US); Ju-wei Chen, Seattle, WA (US); Abbas Pirnia, Brisbane City (AU)

(21) Appl. No.: 16/822,427

(22) Filed: Mar. 18, 2020

(51) Int. Cl. G06Q 30/06; G06F 16/9535; G06F 16/9538; H04W 4/14

(52) U.S. Cl. CPC G06Q 30/0631; G06Q 30/0635; H04W 4/14; G06F 16/9535; G06F 16/9538; G06Q 30/0641

(57) ABSTRACT

Systems and methods for substitute item selection are presented. The methods include providing for presentation first user interface data comprising item preference information representing a substitution preference of an item, a first user interface generated with the first user interface data being configured to receive a change command from a user, wherein the first user interface comprises a unified substitution preferences user interface available from a plurality of order building stages. The methods also include providing for presentation second user interface data in accordance with receiving the change command, a second user interface generated with the second user interface data being configured to present an item substitution suggestion, and to receive item substitution information. The methods also include receiving the item substitution information via the second user interface and storing the item substitution information in a data store.

### BACKGROUND

Logistics systems experience failures that sometimes necessitate substitutions of items for which a supply is unavailable. In some instances, unavailability is difficult to predict, such that difficulties arise with maintaining inventory data that accurately reflect supply levels in the future. In some instances, items such as goods or services are ordered from a catalog of items based on item availability data that a fulfillment system cannot complete. Some conventional logistics systems adjust for unavailable items by requiring manual user confirmation of individual item substitutions, or by selecting another item without user input and generating a notification of the substitution. Such systems can introduce inefficiency into fulfilment systems by, for example, requiring order building to wait for a response to a message, and/or can impair the user experience by delivering undesired items without input from users.

### BRIEF DESCRIPTION OF THE DRAWINGS

Various embodiments in accordance with the present disclosure will be described with reference to the drawings, in which:

FIG. 1 is a block diagram illustrating an example system for item substitution preference selection, in accordance with at least one embodiment;

FIG. 2 is another block diagram illustrating an example ordering user interface for item substitution preference selection, in accordance with at least one embodiment;

FIG. 3 is another block diagram illustrating an example fulfillment system for item substitution preference selection, in accordance with at least one embodiment;

FIG. 4 is another block diagram illustrating another example system for item substitution preference selection, in accordance with at least one embodiment;

FIG. 5 is a user interface diagram illustrating an example technique for item substitution preference selection, in accordance with at least one embodiment;

FIG. 6 is another user interface diagram illustrating another example technique for item substitution preference selection, in accordance with at least one embodiment;

FIG. 7 is another user interface diagram illustrating another example technique for item substitution preference selection, in accordance with at least one embodiment;

FIG. 8 is another user interface diagram illustrating another example technique for item substitution preference selection, in accordance with at least one embodiment;

FIG. 9 is another user interface diagram illustrating another example technique for item substitution preference selection, in accordance with at least one embodiment;

FIG. 10 is another user interface diagram illustrating another example technique for item substitution preference selection, in accordance with at least one embodiment;

FIG. 11 is another user interface diagram illustrating another example technique for item substitution preference selection, in accordance with at least one embodiment;

FIG. 12 is another user interface diagram illustrating another example technique for item substitution preference selection, in accordance with at least one embodiment;

FIG. 13 is another user interface diagram illustrating another example technique for item substitution preference selection, in accordance with at least one embodiment;

FIG. 14 is a flowchart illustrating an example of a process for item substitution preference selection according to certain embodiments;

FIG. 15 is another flowchart illustrating an example of a process for item substitution preference selection according to certain embodiments;

FIG. 16 is another flowchart illustrating an example of a process for item substitution preference selection according to certain embodiments;

FIG. 17 is a diagram illustrating an example architecture for implementing a user interface selection technique, in accordance with at least one embodiment; and

FIG. 18 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In accordance with at least one embodiment, item substitution may be improved by integrating user preferences for substitute items into the ordering user experience and/or the fulfillment system building orders. In some embodiments, user substitution preferences are provided at multiple points in an order process, and an item substitution preference is defined based at least in part on a user selection of a similar item and/or a textual instruction. In some embodiments, the fulfillment system uses user substitution preferences to improve performance and/or efficiency of the order building, by implementing integrated communication and recommendation systems to minimize substitution decisions during order fulfillment. In some embodiments, the user confirms a new preference based at least in part on the substitution and modifies the user substitution preference thenceforth until the next modification thereby persisting item substitution user preferences throughout the user experience.

Techniques described herein include a system for item substitution in order fulfillment according to a substitution suggestion and/or user substitution preferences. In some embodiments, the system includes one or more users, a user ordering interface, and a fulfillment system. The elements of the system may communicate through a network. In some embodiments, a user may select one or more items from an online catalog in a browser to generate an online order. The order may include an item that is eligible for a substitution preference, for example, in case logistics delays or supply shortfalls have occurred for the item. In some embodiments, the user may access a substitution preferences page associated at least in part with the order (e.g., in a browser environment), such that the substitution preferences for the item and/or for all items in the order may be specified. Item substitution preferences may include, but are not limited to, specific item selections, similar item selections, and/or non-substitution selections (sometimes called “do not substitute” selections). In some embodiments, the user may provide textual instructions describing one or more attributes and/or features of the item to guide selection of a similar item. In some embodiments, the user may provide one or more attributes via the user interface, based at least in part on identification of influential or key attributes identified from analysis of aggregated order data from previous substitutions of the item. In some embodiments, the user may receive a substitution suggestion based on recommended items and/or may select a substitution suggestion based at least in part on prior order data. For example, a substitution suggestion may include, but is not limited to, a substitute item, a non-substitution suggestion if item substitution is unavailable, a previously selected item with a user preference, and the like.

In some embodiments, substitution preferences may be provided via the network to the fulfillment system as substitution directions to guide a user of the fulfillment system, for use during order fulfillment. Substitution directions may be presented to reduce a number of decisions made during order fulfillment, thereby improving system performance. In some embodiments, the fulfillment system may include an inventory management subsystem and a user interface implemented in a user device, to provide the substitution directions as part of the order summary for use during order fulfillment. In some embodiments, the fulfillment system may identify item unavailability by comparing the order to the inventory, and may invoke a substitution direction to select a substitute item for the unavailable item. In some embodiments, the substitution is based at least in part on a list of similar items, for example, when the substitution preference indicates a substitution is expected but no specific item is names, or, when a specific item is named, but the specific item is also unavailable. In some embodiments, the similar item is selected and a notification is generated for confirmation that the substitution is accepted. In some embodiments, the substitution direction permits the fulfillment system to operate more efficiently by not repeatedly holding for feedback and may reduce waste by selecting items that are preferred substitutions by the user. In some embodiments, a substitution is recorded in the order and the user is prompted to modify the substitution direction to present the substitute item as a preferred substitution. In some embodiments, the interactions between the user and the fulfillment system, as well as the substitution directions, are used for improvement of similar item recommendations and substitution item selections to potentially improve the performance of the fulfillment system, the ordering system, and the user experience.

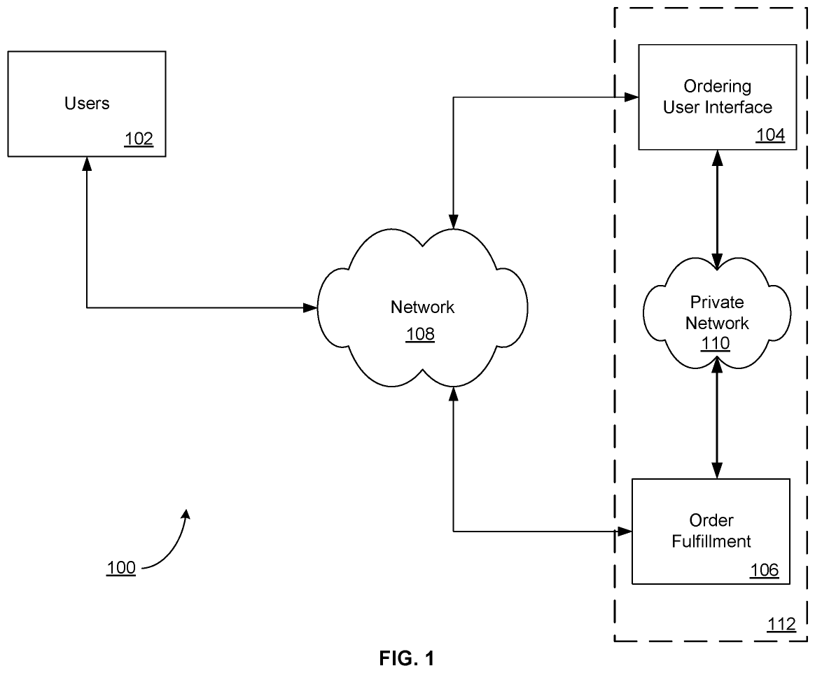

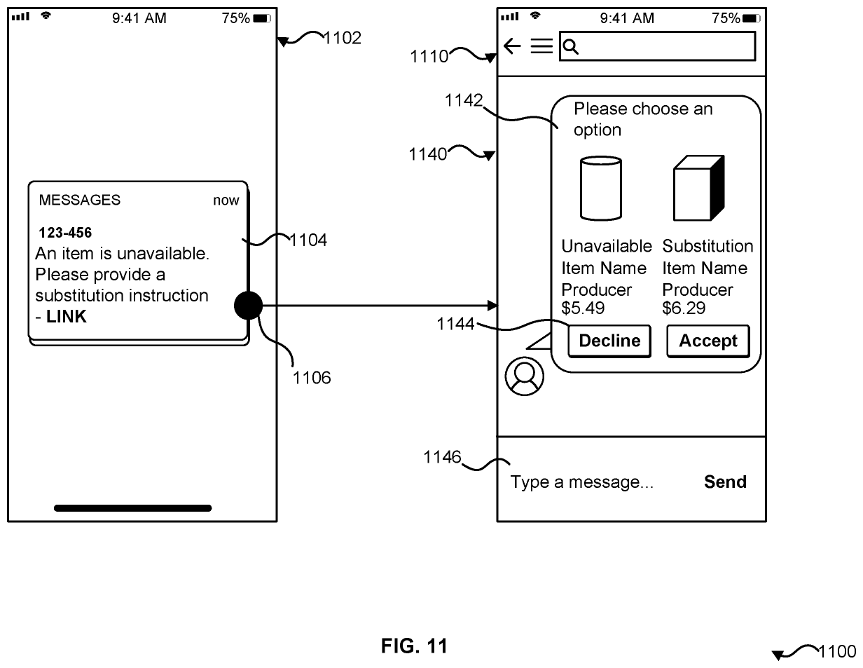

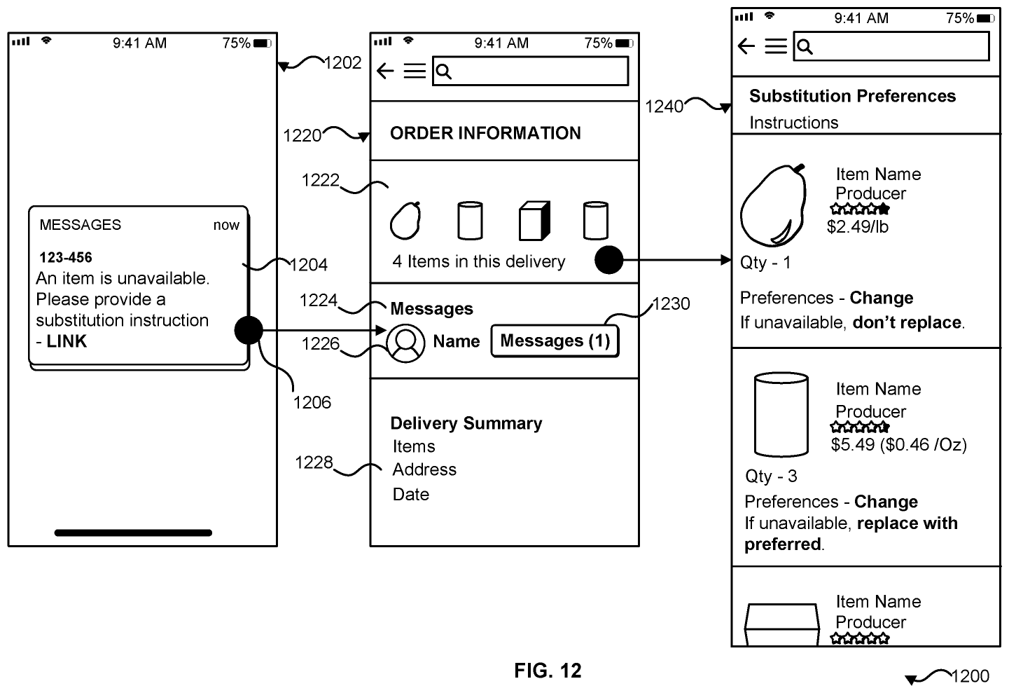

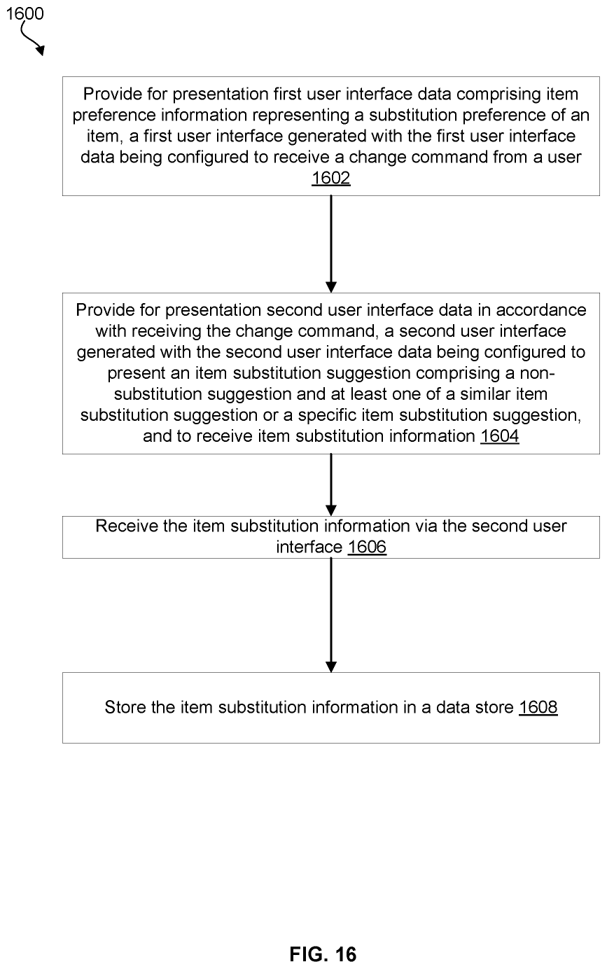

FIG. 1 is a block diagram illustrating an example system 100 for item substitution preference selection, in accordance with at least one embodiment. In some embodiments, the system 100 includes multiple interacting subsystems including, but not limited, to one or more users 102 that interact with an ordering user interface 104, for example, via a browser environment implemented in a mobile device, and an order fulfillment subsystem 106, via a network 108. As described in more detail in reference to FIGS. 16-16, below, in some cases, the network may include a distributed computing system (e.g., a “cloud” computing platform) and/or a dedicated server system. In some embodiments, system 100 includes a back-end system 112, whereby the ordering user interface 104 and the order fulfillment subsystem 106 communicate via a private network 110, rather than via the network 108 through which users 102 communicate. In some cases, the order fulfillment subsystem 106 includes an order fulfillment user device (e.g., a dedicated mobile device hosting one or more applications connecting the mobile device to the network 108 and/or the private network 110), through which a user of the order fulfillment user device may send and receive order information from the users 102 via the ordering user interface 104. In some cases, the order fulfillment user device may provide notifications and/or communication with the users 102 via the network 108, for example, via text, images, sounds, and/or dynamic functionality including, but not limited to functional messages including javascript and/or flash active elements, and the like, as described in more detail in reference to FIGS. 11-12.

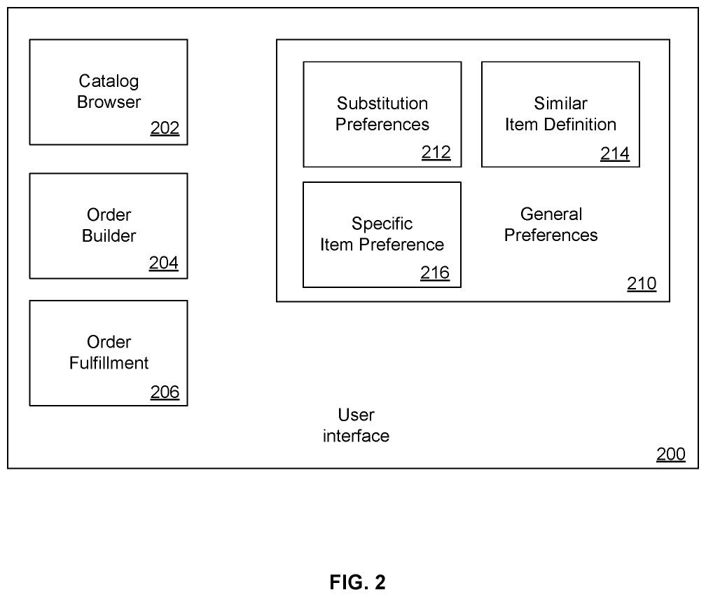

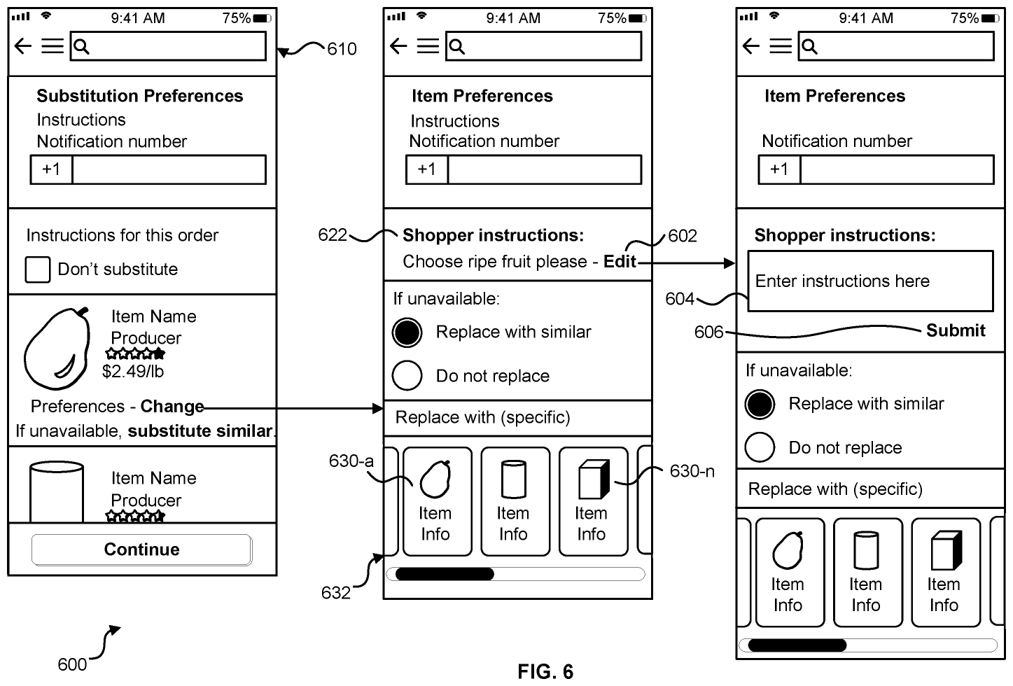

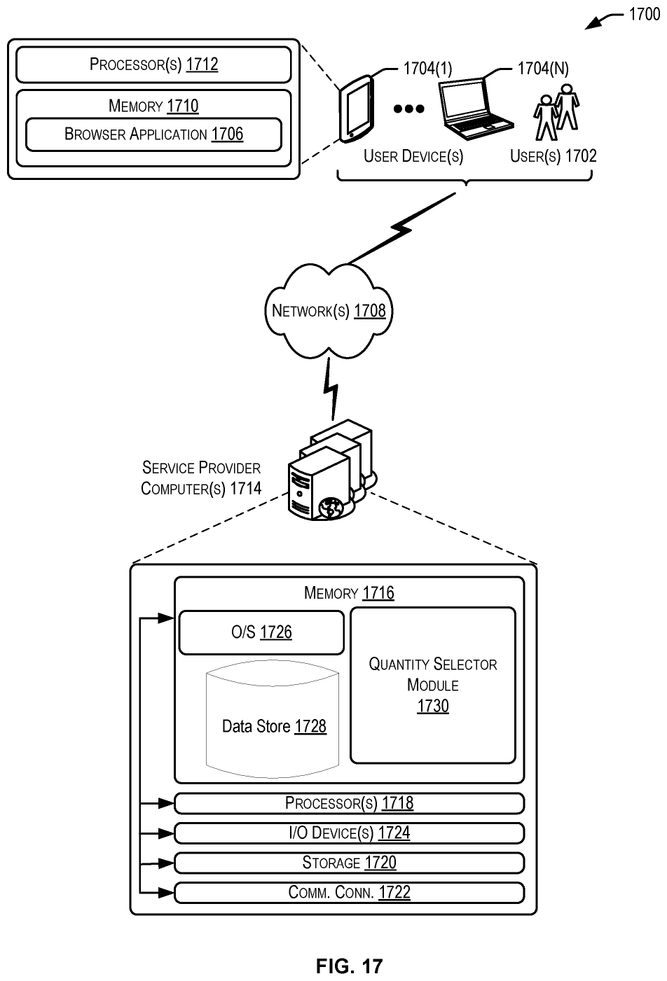

FIG. 2 is another block diagram illustrating an example ordering user interface 200 for item substitution preference selection, in accordance with at least one embodiment. In some embodiments, the user interface (UI) 200 includes a browsing environment that includes user interface elements including, but not limited to a catalog browser element 202, an order builder element 204, an order fulfillment element 206, and a general preferences element 210. In some cases, the general preferences element 210 is implemented into the UI 200 as a functional module adding specific functions to the user interface, at least in part associated with item substitution preference selection. The UI 200 may be implemented as part of an interactive environment including, but not limited to, a client-side dynamic web page, a server-side dynamic web page, a mobile application (e.g., an “app”), etc. In some embodiments, the general preferences element 210 is incorporated into UI 200 including, but not limited to, an item detail page, an order summary page, a checkout page, an order review page, and/or as a dedicated general preferences page, as described in more detail with reference to FIGS. 6-13. In some embodiments, general preferences element 210 includes a substitution preferences sub-element 212, providing functionality for the user interface 200 to present, receive, store, and/or transmit user substitution preferences. In some cases, the general preferences UI element 210 may store substitutions preference information in a data store, for example, locally on a user device, via a network on an application server, and/or in a distributed cloud storage system, as described in more detail in reference to FIGS. 16-17.

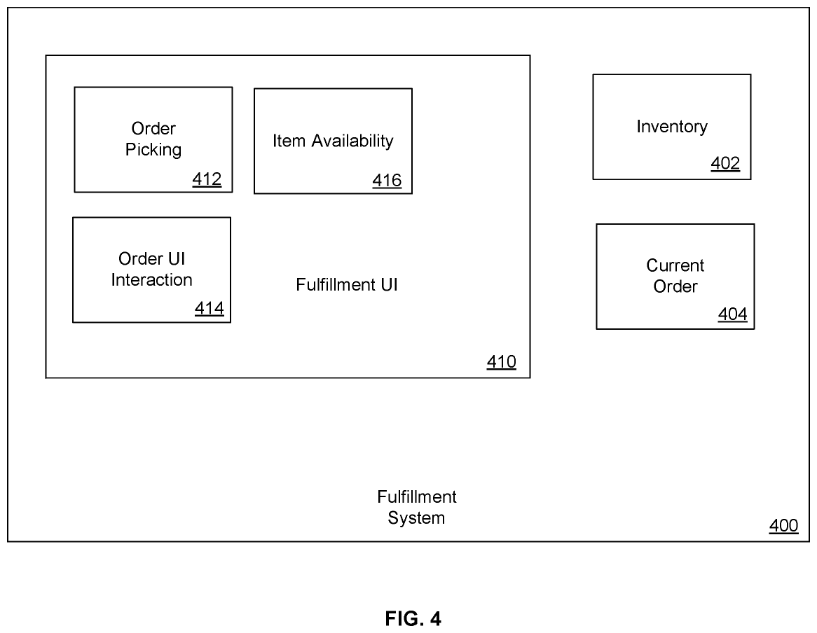

In some embodiments, the general preferences UI element 200 includes a similar item definition sub-element 214, including functionality for identifying one or more items from an item catalog that are characterized by a sufficient degree of similarity, as determined by a similarity criterion, as described in more detail in reference to FIG. 4. In some cases, the similar item definition sub-element 214 of the UI 200 generates a list of similar items for including in substitution preferences as identified and generated by the substitution preferences sub-element 214. In some cases, the general preferences element 210 includes a specific item preference sub-element 216 that may provide functionality permitting the UI 200 to present, receive, store and/or transmit specific item substitution preferences for an item as provided by the user via the UI 200. In some cases, the specific item preference sub-element 216 presents one or more items from the list of similar items to a user (e.g., users 102 of FIG. 1) via the UI 200, whereby the user indicates a specific item substitution preference that may be stored and/or transmitted to a back-end system (e.g., back-end system 112 of FIG. 1), for example, to identify a suitable substitute item.

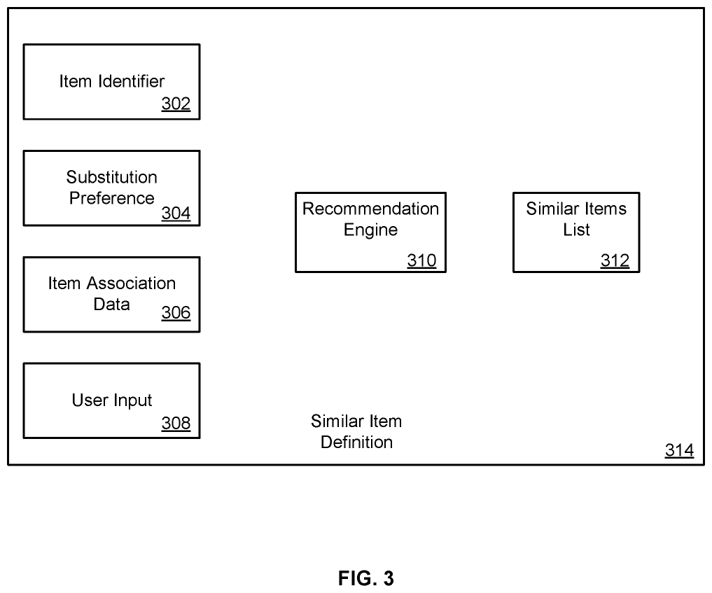

FIG. 3 is another block diagram illustrating a user interface sub-element for similar item definition 314, in accordance with at least one embodiment. Similar item definition sub-element 314 of FIG. 3 is an example of similar item definition sub-element 214 of FIG. 2. In some cases, the similar item definition sub-element 314 is configured to reference a list of similar items 312 for an item in a list of items in an order as generated by an order builder UI element (e.g., order builder element 204 of FIG. 2). In some cases, the list of similar items is pre-defined based on one or more indicia of similarity, as determined by a client of the similar item definition sub-element 314 (e.g., a developer of the user interface 200 and/or the general preferences element 210). In some cases, the list of similar items 312 is generated by defining a feature-space based at least in part on one or more features of the item, such that additional items may be compared to the item in the feature-space. In some cases, additional items that are within a threshold proximity of the item in the feature-space are included in the list of similar items (e.g., by defining a separation function and/or distance function to cluster feature data, for example, using an unsupervised learning model implemented in a convolutional neural network). In some cases, the list of similar items is generated algorithmically, for example, by a recommendation engine 310, based at least in part on an item identifier 302 including, but not limited to, item identification codes, numbers, and/or classifications (e.g., the item may be classified in the catalog in a manner that encodes one or more features of the item into a single identifier, such as an alpha-numeric code number). In some embodiments, the similar item definition sub-element 314 includes as inputs to the recommendation engine 310 a substitution preference 304 for one or more similar items previously indicated by a user of the ordering user interface (e.g., ordering user interface 104 of FIG. 1). In some embodiments, the substitution preference 304 may be supplemented with aggregated item association data 306 from the data store including, but not limited to, data reflecting trends in item substitution preferences of multiple users of the ordering user interface. For example, the recommendation engine may receive item association data indicating a frequent substitution preference of a particular substitution item as a substitution for the item, based at least in part on statistical analysis of a statistically significant dataset of previous substitutions. In some embodiments, the similar item definition sub-element 314 may also include user input 308 including, but not limited to, user selection of specific substitute items in previous orders, affirmative confirmation by the user of a previous substitution of the item, and user preference information indicating preference and/or distaste for one or more substitute items otherwise included in the similar items list 312.

FIG. 4 is another block diagram illustrating a fulfillment system 400 for item substitution preference selection, in accordance with at least one embodiment. In some embodiments, as described in more detail in reference to FIG. 1, the system 100 includes a back-end sub-system 112 that includes the fulfillment system 400. In some embodiments, the fulfillment system includes inventory 402, which may include, but is not limited to a registry of one or more items available for inclusion in an order. The inventory 402 may be described by a dynamic list stored in a data store and accessible via a network (e.g., network 108 and/or private network 110). In some embodiments, the fulfilment system 400 includes a current order element 404, for receiving, storing and/or presenting an order generated by the ordering user interface (e.g., ordering user interface 104 of FIG. 1), such that a user of the fulfillment system 400 (e.g., a shopper, client, picker, etc.) may select appropriate items from inventory 402 to fulfill the current order 404. In some embodiments, the fulfilment system includes a fulfillment UI 410 that may be implemented in a mobile user device (e.g., a tablet, a smartphone, and/or a dedicated order-fulfillment user device). In some cases, the fulfillment UI 410 may include one or more UI elements to facilitate item substitution in the event of mismatch between the current order 404 and the inventory 402, for example, when an item is unavailable. In some cases, the fulfillment UI 410 includes an order picking element 412 that may receive, generate, store, and/or present, information associated at least in part with the current order 404, such that the user of the fulfillment UI 410 may identify one or more items from inventory 402. The order picking element 412 may include information including, but not limited to item information (e.g., item name, item image, item identifier, etc.), item location in a physical space (e.g., a warehouse), logistical management systems (e.g., operational controls for logistical assistance and/or communication between the fulfillment system 400 and automated subsystems such as mobile shelving units, etc.), and/or a sequence by which the user of the fulfillment UI 410 should pick items to fulfill the current order 404.

In some cases, the fulfillment UI 410 may include an item availability element 416 for generating, presenting, storing, and/or transmitting information describing items from current order 404 that are unavailable in inventory 402, necessitating a selection of a substitute item. In such instances, the fulfillment UI 410 may present a substitution direction provided from a user of the ordering UI (e.g., ordering UI 104 of FIG. 1). As described above, a substitution preference received from the user of the ordering UI may be presented to the user of the fulfilment UI 410 as a direction that may improve efficiency of the fulfilment system. The item availability element 416 may present information including, but not limited to item substitution directions, one or more similar items, and additional information provided by a user of the ordering user interface when selecting the relevant item, as described in more detail in reference to FIG. 6. For example, the item availability element may compare a list of similar items (e.g., similar items list 312 of FIG. 3) against the inventory 402 to identify which items in the list of similar items are available in inventory 402. In the absence of item substitution directions, the availability element 416 may provide an automatically generated substitution direction without input by a user of the ordering UI.

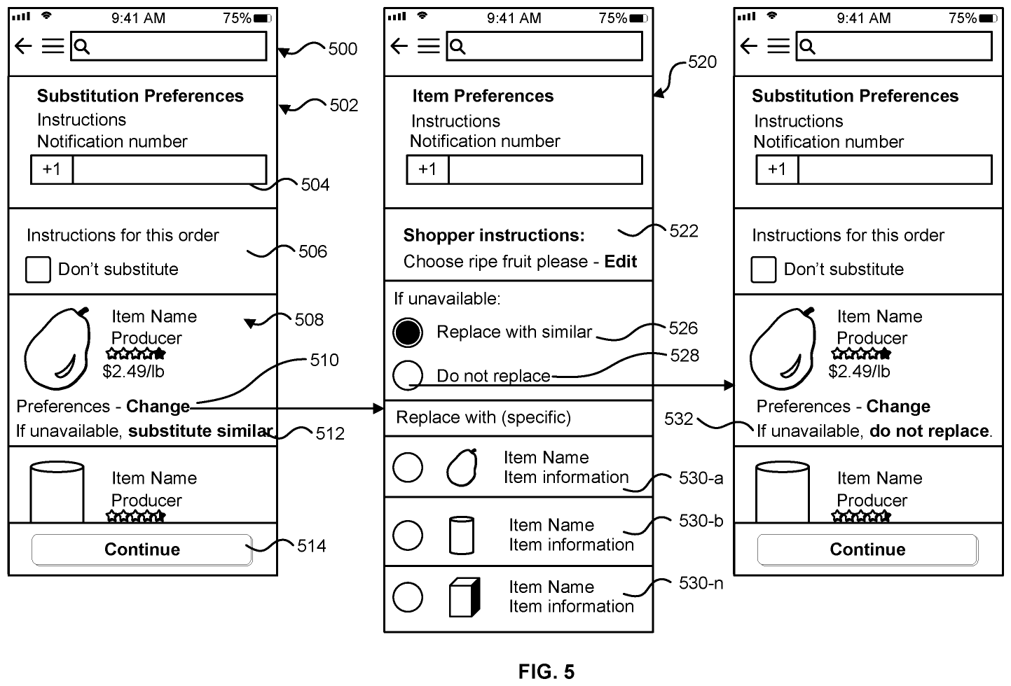

In some cases, the item availability element 416 may generate a notification indicating that an item is unavailable and/or that a substitution is needed, for example, for which the current order 404 lacks substitution direction information. In some embodiments, the fulfillment UI 410 includes an order UI interaction element 414, whereby the user of the fulfillment UI 410 may interact with the user of the ordering UI (e.g., ordering UI 104) at least in part to provide notification of a substitution and/or to prompt for substitution direction information, as described in more detail in reference to FIGS. 11-12. In some cases, the fulfillment UI 410 may provide a notification of a substitution at least in part using the order UI interaction element 414, as a means of receiving confirmation that an item substitution is acceptable to the user (e.g., users 102 of FIG. 1). Similarly, the order UI interaction element 414 may provide confirmation of an item substitution, as well as other information related to fulfillment of the current order 404. In some cases, the order UI interaction element 414 may facilitate communication via internet messaging protocols and/or cellular networks, For example, as described in more detail in reference to FIG. 1, the ordering UI may include a UI element for receiving a phone number as part of substitution direction information, as described in more detail in reference to FIG. 5. Communication via the user interaction element 414 may include, but is not limited to, text, images, sound, and dynamic elements (e.g., javascript and/or flash elements to provide functionality such as interactive buttons and/or other elements).

FIG. 5 is a user interface diagram illustrating an example technique for item substitution preference selection, in accordance with at least one embodiment. In some embodiments, a browser environment 500 includes an ordering user interface (UI) (e.g., the ordering user interface 104 of FIG. 1) that includes one or more sub-elements configured to receive item substitution preferences. In some embodiments, the ordering UI includes a substitution preferences page 502, for presenting item information and configured such that a user (e.g., users 102 of FIG. 1) of the substitution preferences page 502 may indicate and/or modify substitution preferences. In some embodiments, the substitution preferences page 502 includes an interactive sub-element configured to receive a telephone number 504, for facilitating communication between the user and a back-end system (e.g., order fulfillment 106 of FIG. 1). In some cases, for example, when the browser environment 500 is implemented on a desktop or laptop computer, the telephone number sub-element 504 may permit direct communication with a separate user device including, but not limited to, a smartphone, tablet, wearable, and the like. In some embodiments, the ordering UI includes a sub-element for specifying global substitution preferences 506 for all items currently included in an order by an order compilation UI element (e.g., order builder 204 of FIG. 2). In some cases, the global substitution preferences sub-element 506 may be configured to set item substitution preferences for each item in the order. In some cases, the global substitution preferences sub-element 506 may be configured to present multiple substitution preference options, with varying degrees of uniformity. For example, substitution preference options may include, but are not limited to, non-substitution, substitute similar, substitute perishable, substitute non-perishable, substitute above a minimum item price, substitute below a minimum item price. In some embodiments, the global substitution preferences sub-element 506 may be configured to store preferences received in the data store for reference as default substitution preferences in all cases where item-specific preferences are unavailable.

In some embodiments, the substitution preferences page 502 includes one or more item-specific sub-elements 508 describing items in the order at least in part by using item descriptor information including, but not limited to an image of the item, an item name, an item producer, an indicator of item quality and/or popularity, an item price, and/or an item quantity. In some embodiments, the item-specific sub-element 508 may include a summary of the current item substitution preference 512 (e.g., “If unavailable, substitute similar”), and/or a user-interactive element 510 (e.g., a hyperlink, UI button, or other active element) to add and/or modify the item specific substitution preference. In some embodiments, the substitution preferences page 502 includes elements of the ordering UI, including, but not limited to active elements such as a continue button 514, a search button, and other sub-elements included in the browsing environment 500.

In some embodiments, the ordering UI includes an item-specific substitution preferences page 520, which may be generated in accordance with interaction with interactive element 510 to receive item substitution information. Item substitution information may include one or more descriptions of the options available for a user of the item-specific substitution preferences page 520 to specify a substitution preference. In some embodiments, item substitution information includes at least one of a textual instruction, a select-similar instruction, a select-specific instruction, or a non-substitution instruction. In some cases, item-specific substitution preferences page 520 includes some sub-elements in common with substitution preferences page 502, including but not limited to notification information (e.g., telephone number sub-element 504) and/or instructions, active elements, and the like. In some embodiments, item-specific substitution preferences page 520 may include a textual instruction sub-element 522 for receiving, presenting, storing, and/or transmitting textual instructions associated at least in part with substitution preferences for the item. In some embodiments, the textual instructions may relate to the condition and/or format of the item (e.g., “choose ripe fruit please” or “select individually wrapped in a box of more than 20”). In some embodiments, the textual instructions may be stored in the data store and referenced by a fulfillment system (e.g., order fulfillment 106 of FIG. 1) for presentation in a fulfillment UI (e.g., fulfillment UI 410 of FIG. 4). In some embodiments, the item-specific substitution preferences page 520 may include one or more active elements for receiving an item substitution preference, including, but not limited to, a select-similar element 526, a non-substitution element 528, and/or one or more select-specific elements 530a-n, where a-n are positive integers, and n is the number of substitute-specific elements (e.g., if three substitute specific elements are included in item-specific substitution preferences page 520, n=3). In some cases, the substitute-similar element 526 is configured to receive, present, store, and/or transmit a substitution preference to the back-end system (e.g., back-end system 112 of FIG. 1) to reference a list of similar items generated for the item, as described in more detail in reference to FIGS. 2-3. In some embodiments, the non-substitution element 528 modifies the substitution preference for the item to indicate that a substitute item should not be selected in the event that the item is unavailable in inventory (e.g., inventory 402 of FIG. 4). In some embodiments, the select-specific elements 530a-n may present one or more similar items (e.g., from similar item list 312 of FIG. 3) in accordance with a substitution suitability measure, as described in more detail in reference to FIGS. 2-3. In some embodiments, the ordering UI receives, via the item-specific substitution preferences page 520 an item substitution preference (e.g., through interaction with one of the active elements), prompting the generation of the substitution preferences page 502 with new, updated, and/or modified substitution preference information 532. In some cases, the item specific substitution preference may modify or replace the global substitution preference, for example, by implementing a new substitution preference that is mutually exclusive with the global substitution preference. As an example, the global substitution preference may include “substitute imperishable only,” while the item specific substitution preference may indicate a substitution preference for a perishable item such as, for example, “replace with similar” accompanied by a textual instruction 522 of “choose ready to eat.”

FIG. 6. is another user interface diagram illustrating another example technique 600 for item substitution preference selection, in accordance with at least one embodiment. As described in more detail in reference to FIG. 1, a browser environment 610 (e.g., browser environment 500 of FIG. 5) may include an ordering UI (e.g., ordering UI 104 of FIG. 1), including, but not limited to, an item detail page, an order summary page, a checkout page, a cart page, a substitution preferences page, and the like. In some cases, as described in more detail in reference to FIG. 5, a change button (e.g. user-interactive element 510 of FIG. 5) associated with an item preferences element, may be configured to receive a change command to generate and/or present an item specific substitution preferences page (e.g., item-specific substitution preferences page 520 of FIG. 5), including a textual instructions element 622. The change command may include a user interaction with the change button, including but not limited to tapping, pressing, pushing, and/or voice interaction (e.g., a voice command or voice-recognition interaction).

In some embodiments, one or more select-specific elements 630-a-n may be arranged in a horizontal-scrolling menu 632, rather than in the vertical arrangement illustrated in FIG. 5. Horizontal arrangement of select-specific elements 630-a-n may improve the efficiency of display area for some screen formats (e.g., some smaller screen formats). For example, in mobile devices, the horizontal arrangement may better suit one-handed navigation and may make more efficient use of display area. Similarly, additional elements may be arranged horizontally as well as vertically throughout the ordering UI.

In some embodiments, the textual instructions element 622 includes an active element for adding and/or modifying the textual instruction 602. The textual instruction modifier element 602 may, at least in part in accordance with a user interaction, prompt the ordering UI to generate and/or present a fillable text field 604 for receiving, presenting, storing, and/or transmitting textual instructions. In addition, the textual instruction modifier element 602 may include an active element for submitting the textual instruction 606 to the back-end system via the ordering UI.

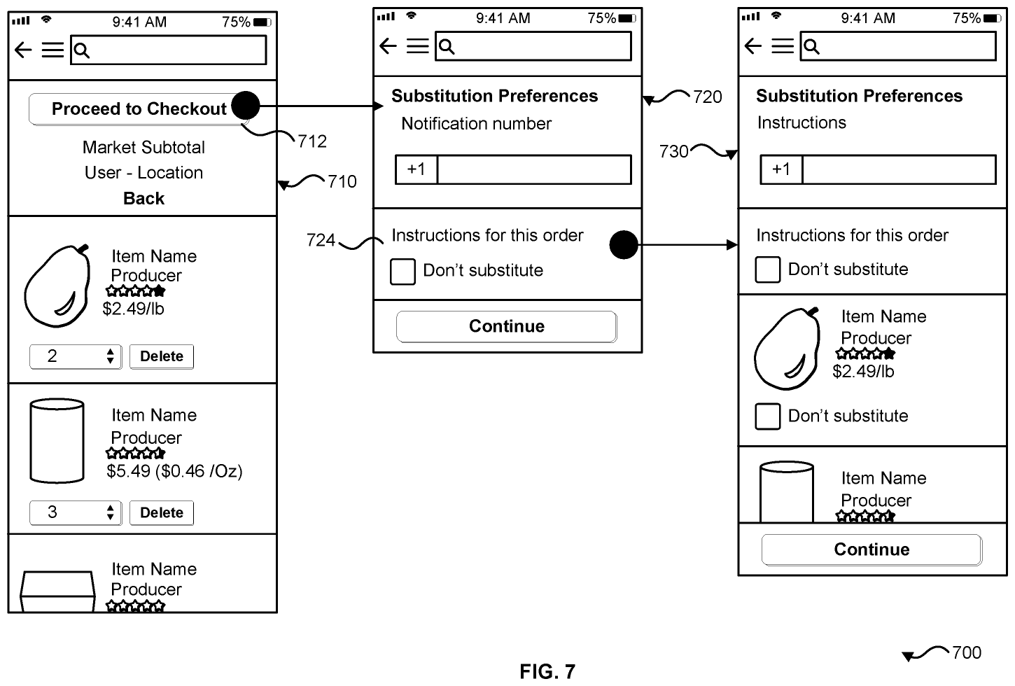

FIG. 7. is another user interface diagram illustrating another example technique 700 for item substitution preference selection, in accordance with at least one embodiment. In some embodiments, as described in more detail in reference to FIGS. 5-6, the ordering UI (e.g., ordering UI 104 of FIG. 1) may generate and/or present a substitution preferences page 720 in accordance with interaction with a user interaction (e.g., tap, press, click) with an active UI element to build an order 712 for transmission to the back-end system (e.g., back-end system 112 of FIG. 1) that is included as part of a checkout page 710. In some embodiments, the substitution preferences page 720 may present contact information, ordering UI, and/or browser environment elements as described in more detail in reference to FIG. 5. In some embodiments, the substitution preferences page 720 may include an interactive element presenting one or more global substitution preferences for the order 724, as described in more detail in reference to FIG. 5. In some cases, interaction with the global substitution preferences element 724 may prompt the ordering UI to generate and/or present an item specific substitution preferences page 730, as described in more detail in reference to FIGS. 5-6.

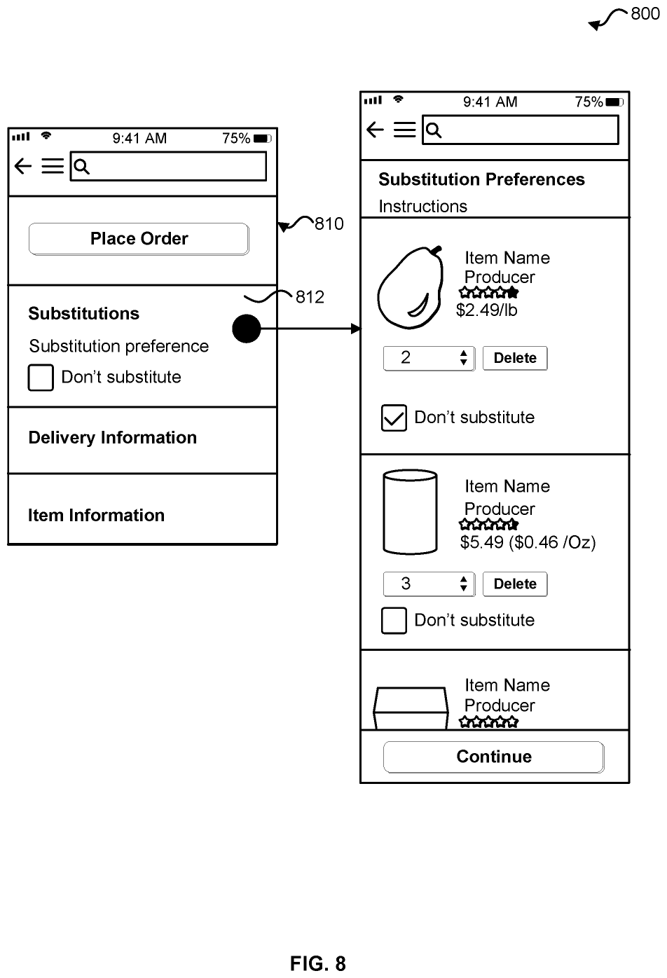

FIG. 8. is another user interface diagram illustrating another example technique 800 for item substitution preference selection, in accordance with at least one embodiment. In a similar way to the technique as described in more detail in reference to FIG. 7, the ordering UI (e.g., ordering UI 104 of FIG. 1) may include an order review page 810 that includes an active element for receiving, presenting, storing, and/or transmitting substitution preferences for the order 812. In some embodiments, the order substitution preferences element 812 may prompt the ordering UI to generate and/or present the item substitution preferences page (e.g., item specific substitution preferences page 730 of FIG. 7).

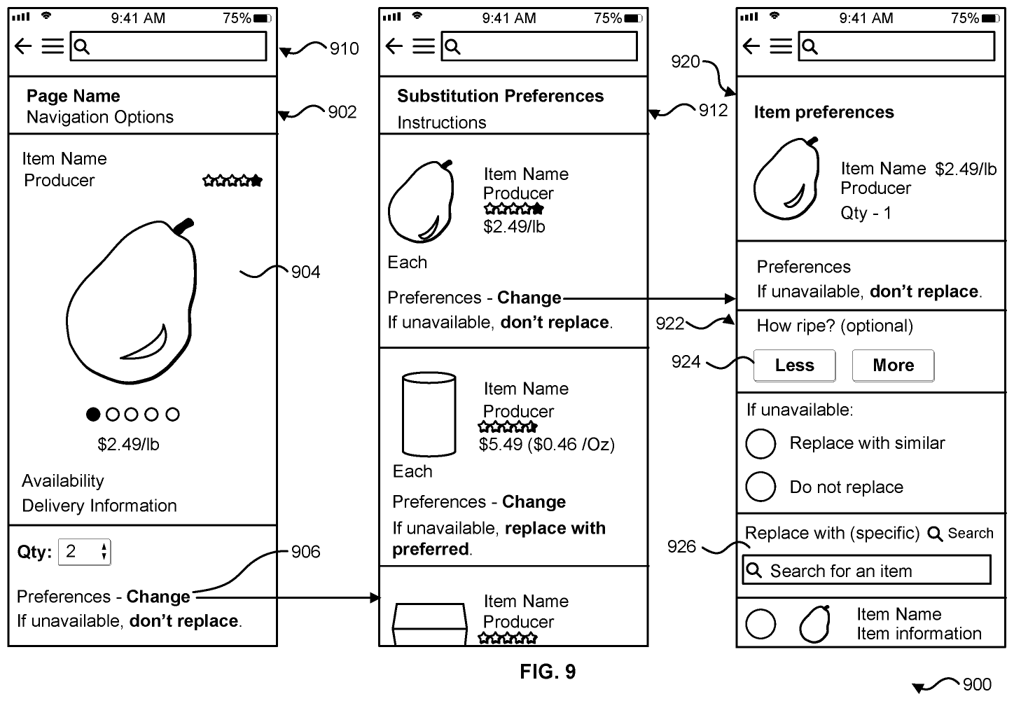

FIG. 9. is another user interface diagram illustrating another example technique 900 for item substitution preference selection, in accordance with at least one embodiment. As described in more detail in reference to FIGS. 5-6, the browser environment 910 (an example of browser environment 500 of FIG. 5) may include an item detail page 902 as one of the pages through which the ordering interface (e.g., ordering UI 104 of FIG. 1) may generate and/or present substitution preferences. In some embodiments, the item detail page 902 may include an item information sheet 904 presenting information including, but not limited to one or more images of the item, the item name, the item producer, an indicator of quality and/or popularity of the item, as well as quantity, availability, and/or delivery information. In some embodiments, the item detail page 902 may include a summary of item substitution preferences and/or a link to change substitution preferences 906. In some embodiments, the ordering UI generates and/or presents, in accordance with user interaction with the substitution preferences change link 906, the substitution preferences page 502, as described in more detail in reference to FIG. 5.

In some embodiments, the ordering UI generates and/or presents an item-specific substitution preferences page 920, in accordance with user interaction with a change preferences element for a specific item in the substitution preferences page 912. In some embodiments, the item-specific substitution preferences page 920 includes elements as described in more detail in reference to FIGS. 5-6, including, but not limited to, item information, one or more substitution options, textual instructions, and the like. In some embodiments, the item-specific substitution preferences page 920 also includes an attribute element 922 for presenting one or more item attributes 924 of the item. In some cases, the attributes 924 are qualitative features or characteristics of the item (e.g., ripe, unripe, fresh, aged). In some cases, the attributes 924 may include quantitative characteristics of the item (e.g., years of aging, vintage, per-unit quantity, etc.). In some cases, the attributes 924 include one or more degrees of a particular attribute presented in the attribute element (e.g., more ripe, less ripe, very spicy, not spicy).

In some embodiments, the attributes 924 may be generated and/or presented by the ordering UI based at least in part on the process of defining similar items (e.g., similar item definition 214 of FIG. 2). For example, in some embodiments, as described in more detail in reference to FIG. 3, aggregated textual instructions from multiple users of the ordering UI may be processed by an implementation of a transformer model in a convolutional neural network to identify important features and attributes of the item that influence substitution preferences for the multiple users. In another example, the analysis of feature-space that permits definition of similar items may also indicate features that exhibit a relatively high influence on the mapping of items in feature-space. In some embodiments, the attributes 924 are selected based on data in the data store from previous orders, for example, by parsing search terms, item returns, complaints, order trends, and the like. In some embodiments, the attributes 924 are defined based on information from an item catalog storing descriptive item identifiers (e.g., catalog browser 202 of FIG. 2).

In some embodiments, the item-specific substitution preferences page 920 may include a search element 926, configured to receive a textual and/or image search query. The search element 926 may be configured to interrogate the data store, for example, by referencing the list of similar items (e.g., similar items list 312 of FIG. 3) to identify and/or present one or more similar items matching the search terms. In some embodiments, the search element 926 may be further configured to present one or more search results as specific item substitution recommendations, as part of the substitution suggestion interface (e.g., select-specific elements 530a-n). In this way, in some embodiments, the search element 926 may provide additional recommended substitute items to the user, beyond the initial list of recommended items provided in substitution suggestions.

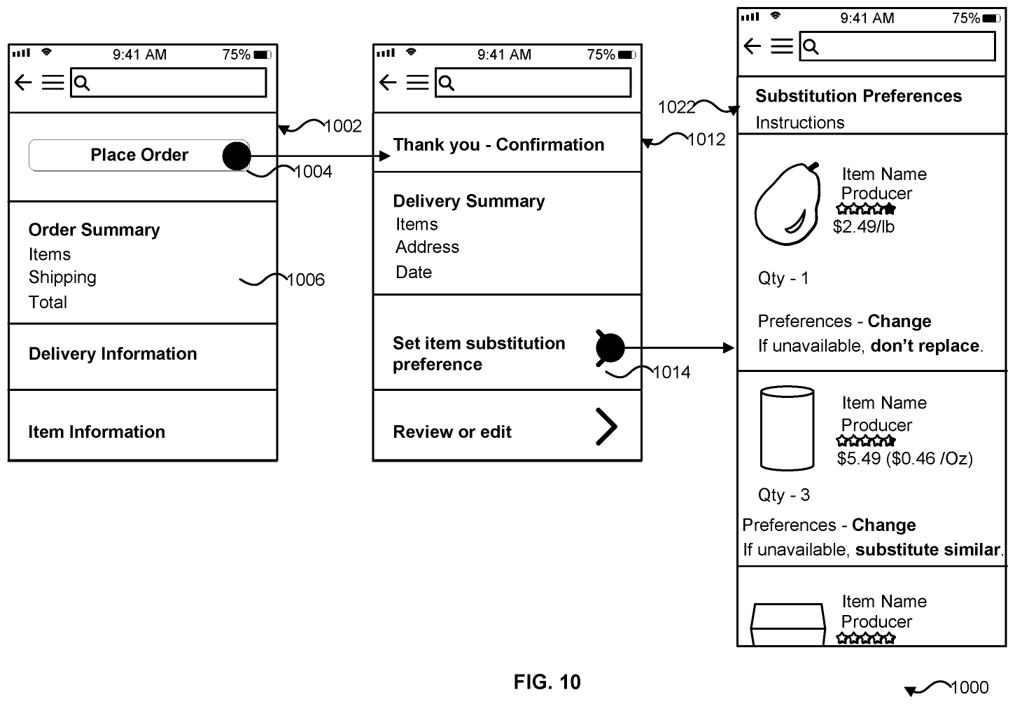

FIG. 10. is another user interface diagram illustrating another example technique 1000 for item substitution preference selection, in accordance with at least one embodiment. In some embodiments, the ordering UI (e.g., ordering UI 104 of FIG. 1), includes an order summary page 1002 that is generated and/or presented at least in part in accordance with user input to build an order. The order summary page 1002 may include one or more active elements for placing the order 1004. In some embodiments, the place order element 1004 prompts the ordering UI to generate and/or present a confirmation and summary page 1010. In some embodiments, the confirmation and summary page 1010 may include an active element for setting substitution preferences 1012. In some embodiments, the ordering UI may generate and/or present the item substitution preferences page 1022 at least in part in accordance with a user interaction associated with the setting substitution preferences element 1012 (e.g., tap, swipe, press, click, etc.).

FIG. 11. is another user interface diagram illustrating another example technique 1100 for item substitution preference selection, in accordance with at least one embodiment. In some embodiments, a notification 1104 may be provided in a device environment 1102, including information at least in part associated with an order generated, received, and/or built by the back-end system (e.g., back-end system 112 of FIG. 1). For example, the device environment 1102 may be generated and/or presented by a device that may include, but is not limited to, a mobile device (e.g., a smart phone, a tablet, etc.), a computer device (e.g., a laptop, desktop computer, or web-terminal, etc.), and a wearable (e.g., a smart watch, an augmented reality device, etc.). In some embodiments, the notification 1104 may be sent as soon as the fulfillment system determines item unavailability. In some embodiments, the determination is made during order fulfillment, such that an immediate response is more suitable for efficient fulfillment. In such cases the notification 1104 may link directly to a communication interface 1140. For example, the notification 1104 may link directly to the communication interface 1140 when the determination of item unavailability is made within one hour of a scheduled order fulfillment operation (e.g., filling an order). Similarly, an immediate response may be sought when the notification 1104 is sent within 10 minutes, 30 minutes, 90 minutes, 120 minutes, etc. of order fulfillment. In some cases, the messaging interface 1140 may be presented in a browsing environment 1110. In some cases, the messaging interface 1140 may use the native messaging application included as part of a mobile device operating system (e.g., a short messaging system (SMS) messaging platform).

In some embodiments, the messaging interface 1140 presents notification messages 1142 including substitution information for an order in progress, as it is being built by the fulfillment system. As described in more detail in reference to FIG. 4, the fulfillment system may generate a notification including information describing an unavailable item and/or a proposed substitution based at least in part on a list of similar items, a specific substitution preference, etc. In some embodiments, the notification message 1142 may include one or more selection elements 1144 (e.g., accept, decline, maybe) for generating a response notification that may be received by the fulfillment UI (e.g., fulfillment UI 410 of FIG. 4) and may be used at least in part to adjust the order build. In some embodiments, the messaging interface includes a textual messaging element 1146 for entering and sending textual and/or audio-visual messages, for example, to respond to a notification message 1142 with a response message not included in the one or more selection elements 1144.

FIG. 12 is another user interface diagram illustrating another example technique 1200 for item substitution preference selection, in accordance with at least one embodiment. In some embodiments, an item unavailability notification 1204 is generated and/or sent by the fulfillment system with enough time before fulfillment such that real time interaction (e.g., two-way chat) and immediate response is less helpful. In such cases, for example, when more than one hour remains before fulfillment of an order the notification 1204 may include an active element including but not limited to a hyperlink, at least in part in accordance with which the device may generate and/or present the browsing environment 1210 (an example of browser environment 500 of FIG. 5), including an order information page 1220, including an item summary element 1222, delivery summary information 1228, and a notification element 1224 presenting an interface element for providing access to notifications from the fulfillment system (e.g., the fulfillment system 400). In some embodiments, the notification element 1224 may include identifier information for the user of the fulfilment UI (e.g., fulfillment UI 411 of FIG. 4) including, but not limited to, a name, an image and/or badge, a rating, and the like. In some embodiments, the notification element may 1224 may include an active element (e.g., a button or link) that may include information describing the number of messages and/or notifications received from the fulfillment system. For example, in some cases a messaging element 1230 may prompt the browser environment 1210 to generate and/or present the messaging interface (e.g., messaging interface 1140 of FIG. 11). Alternatively, interaction with the item summary element 1222 or other elements in the order information page 1220 may cause the ordering UI to generate and/or present the substitution preferences page 1240. In some embodiments, substitution preferences for the unavailable item designated in the notification 1204 may thereby be modified up until order fulfilment begins or within a length of time preceding that time (e.g., one hour, 30 minutes, 10 minutes, etc.).

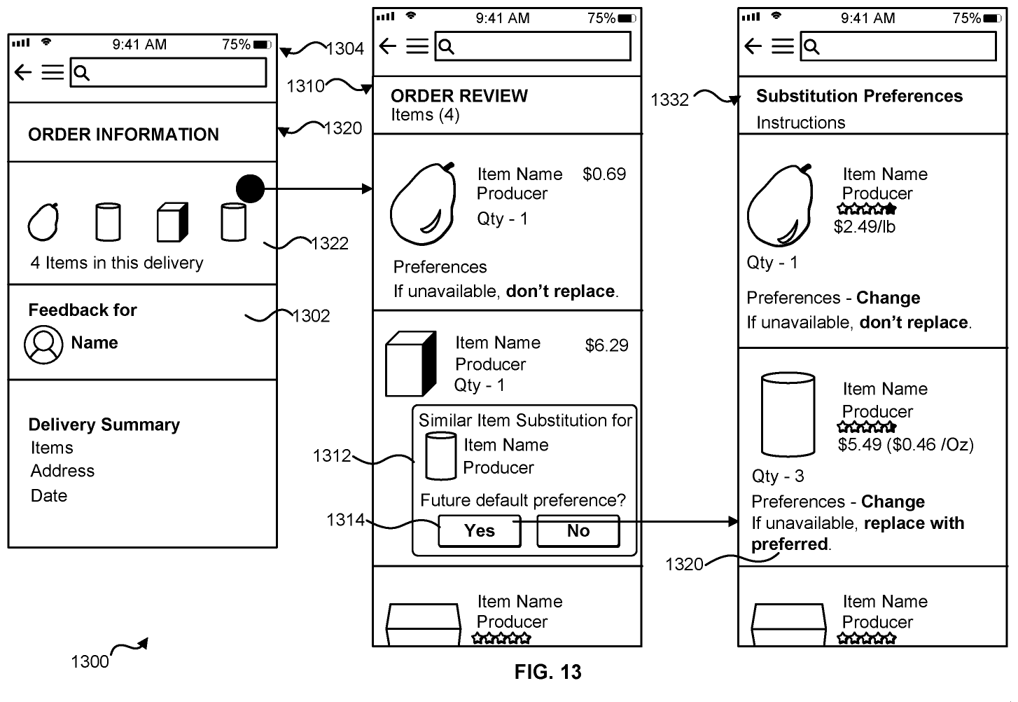

FIG. 13. is another user interface diagram illustrating another example technique 1300 for item substitution preference selection, in accordance with at least one embodiment. In some embodiments, the browser environment 1304 (an example of browser environment 500 of FIG. 5) includes an order information page 1320 that includes item summary element 1322 that may prompt the ordering UI to generate and/or present an order review page 1310 at least in part in accordance with an interaction with the item summary element 1322. In some embodiments, the order information page 1320 includes feedback element 1302 for receiving, storing, and/or transmitting feedback describing the substitution to the fulfillment system (e.g., fulfillment system 400 of FIG. 4). In some embodiments, the order review page 1310 includes at least one item substitution review element 1312. In some embodiments, the ordering UI generates and/or presents the item substitution review element 1312 at least in part in accordance with an item substitution recorded during fulfillment of the order. In some embodiments, the item substitution may have been based on an express acceptance via a notification as described in more detail in reference to FIG. 11, such that the item substitution may have been affirmatively approved as a substitution in that instance. In some embodiments, the item substitution review element 1312 may include information summarizing the substitution including, but not limited to an image of the original ordered item, the producer of the original ordered item, whether the substituted item is a similar item, a preferred item, or a recommended item, and the like. In some embodiments, the item substitution review element 1312 may include at least one active element 1314 for adding, modifying and/or adjusting default substitution preferences for future orders including the originally ordered item. In some embodiments, the ordering UI may generate and/or present the substitution preferences page 1332 (an example of substitution preferences page 502 of FIG. 5) at least in part in accordance with an interaction with the default substitution preferences element 1314, whereby the substitution preferences for the originally ordered item may be updated, modified, and/or adjusted with information at least in part according to selection of the default substitution preferences element 1314. For example, the default substitution preferences element may include two or more interactive buttons including, but not limited to, an acceptance button and a rejection button (e.g., a “yes” button and a “no” button), at least in part in accordance with which the ordering UI may make the substituted item a preferred substitution for the originally ordered item, or may remove the substituted item from the list of similar items and/or adjust the association of the substituted item to the originally ordered item for future orders.

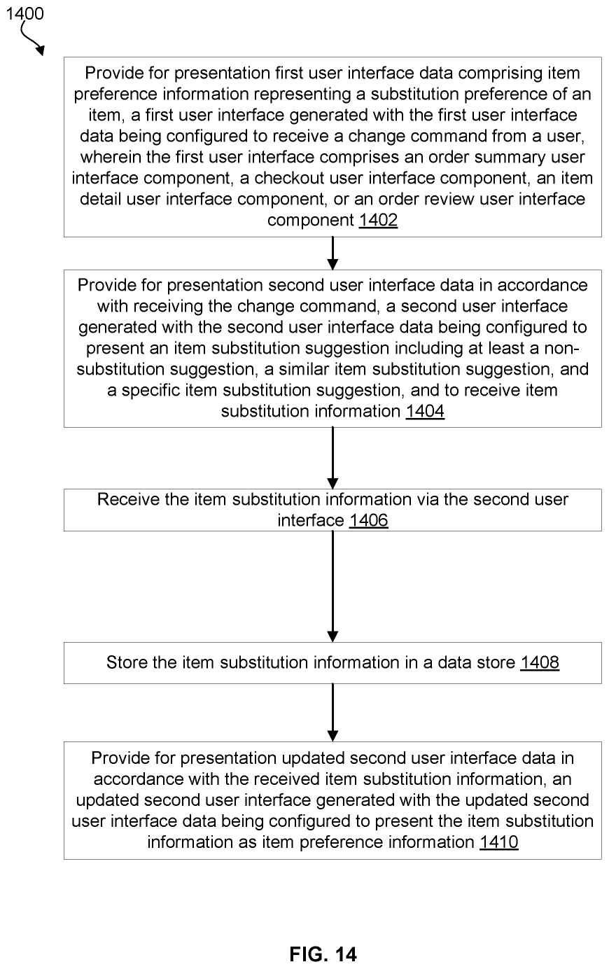

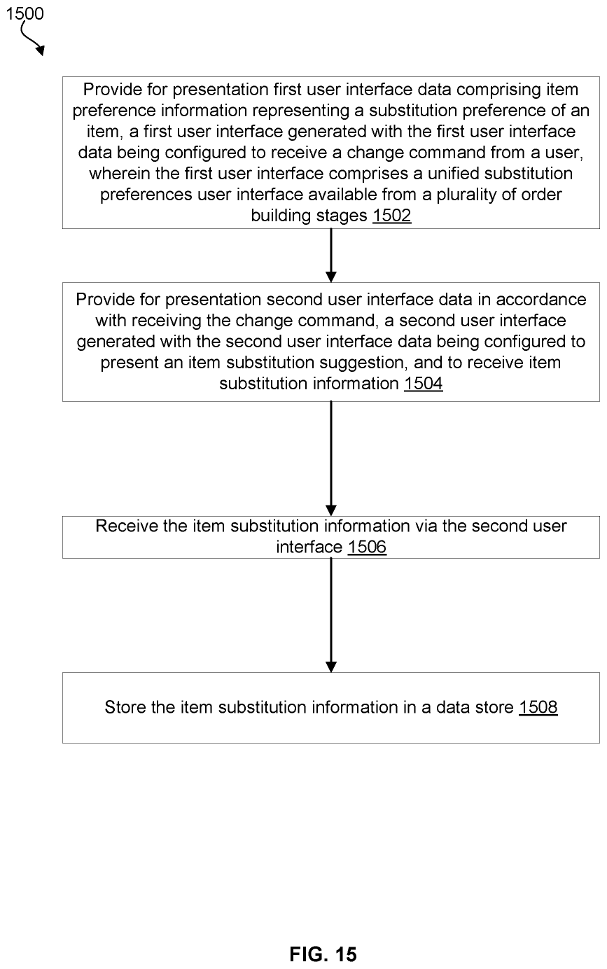

FIGS. 14-15 describe examples of a process for item substitution preference selection according to certain embodiments. Some or all of the processes (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

FIG. 14. is a flowchart illustrating an example of a process 1400 for item substitution preference selection according to certain embodiments. The process includes providing for presentation, by a computing system, first user interface data comprising item preference information representing a substitution preference of an item, a first user interface (e.g., substitution preferences page 500 of FIG. 5) generated with the first user interface data being configured to receive a change command from a user, wherein the first user interface comprises an order summary user interface component (e.g., order summary page 1002 of FIG. 10), a checkout user interface component (e.g., checkout page 710 of FIG. 7), an item detail user interface component (e.g., item detail page 902 of FIG. 9), or an order review user interface component (e.g., order review page 810 of FIG. 8) (1402). As described in reference to FIGS. 1-4, the computer system may generate and/or present a unified user interface component for presenting and/or receiving item substitution preferences from a user (e.g., ordering user interface 104 of FIG. 1). The item substitution preference may be presented in the user interface during multiple steps of the order building process, as described in more detail in reference to FIGS. 5-12. For example, the user may specify item substitution preferences in a cart interface, as part of order summary and/or review, and/or after completion of the order build.

The process further includes providing for presentation, by the computing system, second user interface data in accordance with receiving the change command, a second user interface (e.g., item preferences page 520 of FIG. 5) generated with the second user interface data being configured to present an item substitution suggestion including at least a non-substitution suggestion, a similar item substitution suggestion, and a specific item substitution suggestion, and to receive item substitution information (1404). As described in more detail in reference to FIG. 5, the item substitution suggestion may include one or more options for item substitution preferences including, but not limited to a preference to not substitute an item (e.g., non-substitution element 528 of FIG. 5), to substitute an item with a similar item from a list of similar items specific for the item and/or the user (e.g., select-similar element 526 of FIG. 5), and to provide one or more recommended substitute items in a selectable list to receive a user selection of a preferred substitution (e.g., select-specific elements 530a-n of FIG. 5).

The process further includes receiving, by the computing system, the item substitution information via the second user interface (1406).

The process further includes storing, by the computing system, the item substitution information in a data store (1408). As described in more detail in reference to FIGS. 1-5, the data store may include distributed storage (e.g., a cloud system), centralized storage, and/or local storage on a user device (e.g., data store 1728 of FIG. 17).

The process further includes providing for presentation, by the computing system, updated second user interface data in accordance with the received item substitution information, an updated second user interface generated with the updated second user interface data being configured to present the item substitution information as item preference information (1410). As described in more detail in reference to FIG. 5, the user interface may be updated to reflect the substitution preferences in the second user interface (e.g., modified substitution preference information 532 of FIG. 5). Optionally, the updated second user interface may include an order summary user interface component, a checkout user interface component, an item detail user interface component, or an order review user interface component. In this way, the updated substitution preferences may be reflected throughout the order building process.

Optionally, the process further includes providing for presentation, by the computing system, third user interface data in accordance with receiving notification data, a third user interface (e.g., communication interface 1140 of FIG. 11) generated with the third user interface data being configured to present notification information in accordance with the item substitution information representing a substitution suggestion of the item, and a user preference button (e.g., one or more selection elements 1144 of FIG. 11) configured to receive a user substitution preference for the item. In addition, the process may further include providing, by the computing system, for reception of the user substitution preference via the third user interface in accordance with a user interaction with the user preference button and storing, by the computing system, the user substitution preference in the data store. As described in more detail in reference to FIGS. 11-12, item substitution preferences may be provided and/or confirmed during fulfillment of an order by a fulfillment system using a notification provided via a messaging interface. The messaging interface may be included in the browser environment and/or it may use the native short message service (SMS) platform of a user device (e.g., notification 1104 of FIG. 11). Optionally, wherein in a first condition the notification data is received within a first time from an order fulfillment event, the third user interface comprises a chat user interface component configured to receive the user substitution preference for the item in real time. Optionally, wherein in a second condition the notification data is received within a second time from an order fulfillment event longer than the first time, the third user interface comprises the second user interface. Optionally, notification data may include item substitution information associated with the item comprising at least one of an unavailability notification or an available substitute item notification (e.g., item substitution review element 1312 of FIG. 13). In some embodiments, an order completion event describes the commencement of order fulfillment, the completion of order fulfillment, or the scheduling of order fulfillment.

It should be appreciated that the specific steps illustrated in FIG. 13 provide a particular method of alternative item selection according to an embodiment of the present invention. Other sequences of steps may also be performed according to alternative embodiments. For example, alternative embodiments of the present invention may perform the steps outlined above in a different order. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 15. is another flowchart illustrating an example of a process 1500 for item substitution preference selection according to certain embodiments. The process includes providing for presentation first user interface data comprising item preference information representing a substitution preference of an item, a first user interface generated with the first user interface data being configured to receive a change command from a user, wherein the first user interface comprises a unified substitution preferences user interface available from a plurality of order building stages (1502). As described in more detail in reference to FIG. 15, the unified substitution preferences user interface may include one or more steps in the order building process. Optionally, the plurality of order building stages comprise an order summary user interface component, a checkout user interface component, an item detail user interface component, and an order review user interface component.

The process further includes providing for presentation second user interface data in accordance with receiving the change command, a second user interface generated with the second user interface data being configured to present an item substitution suggestion, and to receive item substitution information (1504). Optionally, the item substitution suggestion further includes at least one of a non-substitution suggestion, a similar item substitution suggestion, or a specific item substitution suggestion; and the item substitution information includes at least one of one of a textual instruction, a select-similar instruction, a select-specific instruction, or a non-substitution instruction. Optionally, the second user interface is further configured to present attribute information (e.g., attribute element 922 of FIG. 9) at least in part in association with a user-selectable button (e.g., attributes 924 of FIG. 9), wherein the attribute information is based at least in part on at least one of aggregated textual instruction information stored on the data store, item identifier information, or item type information from an item catalog. As described in more detail in reference to FIG. 9, the attribute information may provide a qualitative preference option for substitution preference information, for example, by presenting as a user interface component one or more interactive elements associated at least in part with attributes of an item. Optionally, the item substitution suggestion comprises recommended item information based at least in part on an association of a recommended item to the item, using at least one of aggregated item substitution information in the data store or a characteristic item identifier describing the item in an item database. As described in more detail in reference to FIG. 3, recommended item information may be determined by association of an item with a substitute item based at least in part on several factors including but not limited to feature-analysis, item identifier association, prior substitution data, and the like.

The process further includes receiving the item substitution information via the second user interface (1506) and storing the item substitution information in a data store (1508). Optionally, the process further includes providing for presentation updated second user interface data in accordance with receiving the item substitution information, an updated second user interface generated with the updated second user interface data being configured to present the item substitution information as item preference information. As described in more detail in reference to FIG. 15, the substitution information may be presented in updated interface components in one or more stages of the order building process.

Optionally, the process further includes providing for presentation updated second user interface data in accordance with receiving the item substitution information, an updated second user interface generated with the updated second user interface data being configured to present the item substitution information as item preference information. Optionally, the process further includes presenting a user-fillable text field via the second user interface (e.g., search element 926 of FIG. 9), configured to receive the textual instruction; storing the textual instruction in the data store; and the updated second user interface is further configured to present at least a portion of the textual instruction. Optionally, the process further includes receiving search query information via a user-fillable text field included in the second user interface, the search query information describing an item substitution preference; transmitting the search query information to a database system; receiving a query result from the database system describing a recommended item; and presenting the query result in the second user interface as an updated item substitution suggestion. As described in more detail in reference to FIG. 9, a search interface may be configured to receive textual searches to query a list of similar items (e.g., list of similar items 312 of FIG. 3) so that a user may select from items not included in the list of recommended items.

Optionally, the process further includes receiving notification information in accordance with the substitution preference, describing a substitution suggestion of the item. As described in more detail in reference to FIG. 15, this may include providing for presentation third user interface data in accordance with receiving the notification information, a third user interface generated with the third user interface data being configured to present the notification information and a user preference button configured to receive a user substitution preference for the item. The process may further include receiving, via the third user interface, the user substitution preference in accordance with a user interaction with the user preference button, and storing the user substitution preference in the data store.

It should be appreciated that the specific steps illustrated in FIG. 15 provide a particular method of alternative item selection according to an embodiment of the present invention. Other sequences of steps may also be performed according to alternative embodiments. For example, alternative embodiments of the present invention may perform the steps outlined above in a different order. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 16. is another flowchart illustrating an example of a process 1600 for item substitution preference selection according to certain embodiments. The process includes providing for presentation first user interface data comprising item preference information representing a substitution preference of an item, a first user interface generated with the first user interface data being configured to receive a change command from a user (1602). Optionally, the first user interface comprises a unified substitution preferences user interface available from a plurality of order building stages comprising an order summary user interface component, a checkout user interface component, an item detail user interface component, and an order review user interface component. As described in more detail in reference to FIG. 15, the substitution preferences user interface may be used to provide a user with multiple points of ingress to a substitution preferences interface.

The process further includes providing for presentation second user interface data in accordance with receiving the change command, a second user interface generated with the second user interface data being configured to present an item substitution suggestion comprising a non-substitution suggestion and at least one of a similar item substitution suggestion or a specific item substitution suggestion, and to receive item substitution information (1604). Optionally, the item substitution suggestion comprises recommended item information received by the computer system; and the recommended item information is based at least in part on determining a preferred item based at least in part on minimizing a separation function applied to aggregated item substitution information in the data store, as described in more detail in reference to FIG. 3 and FIGS. 14-15. Optionally, the item substitution suggestion comprises recommended item information comprising a plurality of recommended items, based at least in part on prior item substitution information in the data store.

The process further includes receiving the item substitution information via the second user interface (1606) and storing the item substitution information in a data store (1608). Optionally, at least one of the first user interface or the second user interface is further configured to provide for notification information. Optionally, the notification information comprises at least one of an unavailability notification or an available substitute item notification; and the notification information is conveyed using at least one of a short message service (SMS) message, an electronic mail message, or an instant message facilitated by a messaging interface generated with messaging interface data provided by the computer system in accordance with receiving the notification information and configured to present notification information. Optionally, the messaging interface is further configured to present an interactive element (e.g., textual messaging element 1146 of FIG. 11) configured to receive a user preference, to facilitate two-way communication comprising at least one of images or textual instructions, and to receive user substitution instructions using the interactive element, as described in more detail in reference to FIGS. 11-13.

It should be appreciated that the specific steps illustrated in FIG. 16 provide a particular method of alternative item selection according to an embodiment of the present invention. Other sequences of steps may also be performed according to alternative embodiments. For example, alternative embodiments of the present invention may perform the steps outlined above in a different order. Moreover, the individual steps illustrated in FIG. 16 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 17. is a diagram illustrating an example architecture for implementing a user interface selection technique, in accordance with at least one embodiment. In architecture 1700, one or more users 1702 (e.g., customers, users, consumers, etc.) may utilize user computing devices 1704(1)-(N) (collectively, user devices 1704) to access a browser application 1706 or a user interface (UI) accessible through the browser application 1706, via one or more networks 1708. The “browser application” 1706 can be any browser control or native application that can access and display a network page or other information such as a user interface of a native software application for enabling the selection or interaction of content. A native software application may include an application or program that has been developed for use on a particular platform (such as an operating system) or a particular device (such as a particular type of mobile device or user device 1704). In embodiments, the user device 1704 may include one or more components for enabling the user 1702 to interact with the browser application 1706.

The user devices 1704 may include at least one memory 1710 and one or more processing units or processor(s) 1712. The memory 1710 may store program instructions that are loadable and executable on the processor(s) 1712, as well as data generated during the execution of these programs. Depending on the configuration and type of the user devices 1704, the memory 1710 may be volatile (such as random access memory (RAM)) and/or non-volatile (such as read-only memory (ROM), flash memory, etc.). The user devices 1704 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the user devices 1704. In some implementations, the memory 1710 may include multiple different types of memory, such as static random access memory (SRAM), dynamic random access memory (DRAM), or ROM.

Turning to the contents of the memory 1710 in more detail, the memory 1710 may include an operating system and one or more application programs or services for implementing the techniques disclosed herein. Additionally, the memory 1710 may include one or more modules for implementing the techniques described herein including a substitution preferences module 1730 for implementing the processes as described in more detail in reference to FIGS. 14-14.

The architecture 1700 may also include one or more service provider computers 1714 that may, in some examples, provide computing resources such as, but not limited to, client entities, low latency data storage, durable data store, data access, management, virtualization, hosted computing environment or “cloud-based” solutions, electronic content performance management, etc. The service provider computers 1714 may implement or be an example of the service provider computer(s) described herein with reference to FIGS. 1-12 and throughout the disclosure. The one or more service provider computers 1714 may also be operable to provide site hosting, computer application development, and/or implementation platforms, combinations of the foregoing, or the like to the one or more users 1702 via user devices 1704.

In some examples, the networks 1708 may include any one or a combination of many different types of networks, such as cable networks, the Internet, wireless networks, cellular networks, and other private and/or public networks. While the illustrated examples represents the users 1702 communicating with the service provider computers 1714 over the networks 1708, the described techniques may equally apply in instances where the users 1702 interact with the one or more service provider computers 1714 via the one or more user devices 1704 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer arrangements, etc.).

The one or more service provider computers 1714 may be any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the one or more service provider computers 1714 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment or distributed computing environment. In some examples, the one or more service provider computers 1714 may be in communication with the user device 1704 via the networks 1708, or via other network connections. The one or more service provider computers 1714 may include one or more servers, perhaps arranged in a cluster or as individual servers not associated with one another.

In one illustrative configuration, the one or more service provider computers 1714 may include at least one memory 1716 and one or more processing units or processor(s) 1718. The processor(s) 1718 may be implemented as appropriate in hardware, computer-executable instructions, firmware, or combination thereof. Computer-executable instruction or firmware implementations of the processor(s) 1718 may include computer-executable or machine-executable instructions written in any suitable programming language to perform the various functions described when executed by a hardware computing device, such as a processor. The memory 1716 may store program instructions that are loadable and executable on the processor(s) 1718, as well as data generated during the execution of these programs. Depending on the configuration and type of the one or more service provider computers 1714, the memory 1716 may be volatile (such as RAM) and/or non-volatile (such as ROM, flash memory, etc.). The one or more service provider computers 1714 or servers may also include additional storage 1720, which may include removable storage and/or non-removable storage. The additional storage 1720 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 1716 may include multiple different types of memory, such as SRAM, DRAM, or ROM.

The memory 1716, the additional storage 1720, both removable and non-removable, are all examples of non-transitory computer-readable storage media. For example, computer-readable storage media may include volatile or non-volatile, removable or non-removable media implemented in any method or technology for storage of information such as computer-readable instructions, data structures, program modules, or other data. The memory 1716 and the additional storage 1720 are all examples of non-transitory computer storage media. Additional types of non-transitory computer storage media that may be present in the one or more service provider computers 1714 may include, but are not limited to, PRAM, SRAM, DRAM, RAM, ROM, EEPROM, flash memory or other memory technology, CD-ROM, DVD, or other optical storage, magnetic cassettes, magnetic tape, magnetic disk storage or other magnetic storage devices, or any other medium which can be used to store the desired information and which can be accessed by the one or more service provider computers 1714. Combinations of any of the above should also be included within the scope of non-transitory computer-readable media.

The one or more service provider computers 1714 may also contain communication connection interface(s) 1722 that allow the one or more service provider computers 1714 to communicate with a data store, another computing device or server, user terminals, and/or other devices on the networks 1708. The one or more service provider computers 1714 may also include I/O device(s) 1724, such as a keyboard, a mouse, a pen, a voice input device, a touch input device, a display, speakers, a printer, etc.

Turning to the contents of the memory 1716 in more detail, the memory 1716 may include an operating system 1726, one or more data stores 1728, and/or one or more application programs or services for implementing the techniques disclosed herein including the substitution preferences module 1730. In accordance with at least one embodiment, the substitution preferences module 1730 may be configured to provide for presentation first user interface data comprising item preference information representing a substitution preference of an item, a first user interface generated with the first user interface data being configured to receive a change command from a user, wherein the first user interface comprises a unified substitution preferences user interface available from a plurality of order building stages. The first user interface data may be configured for one or more browser environments on a plurality of devices. As described in more detail in reference to FIGS. 1-4, the unified substitution preferences interface may be a part of an order building and fulfillment system for receiving and implementing item substitution preferences for orders between one or more users, an ordering interface, and a fulfillment system, via one or more networks. The substitution preferences module 1730 may be further configured to provide for presentation second user interface data in accordance with receiving the change command, a second user interface generated with the second user interface data being configured to present an item substitution suggestion, and to receive item substitution information. As described in more detail in reference to FIGS. 5-12, the second user interface may be configured to present one or more item substitution preference options for selection, including but not limited to non-substitution, select-similar, and select-specific. The substitution preferences module 1730 may be further configured to receive the item substitution information via the second user interface and to store the item substitution information in a data store. As described in more detail in reference to FIGS. 14-15, the substitution preferences module 1730 may be further configured to generate and/or present a notification interface for communication between the user and the fulfillment system as part of fulfillment processes. In addition, additional features and/or elements, as described in reference to FIGS. 5-12, may be included in one or more of the user interfaces to present and/or receive item substitution suggestions.

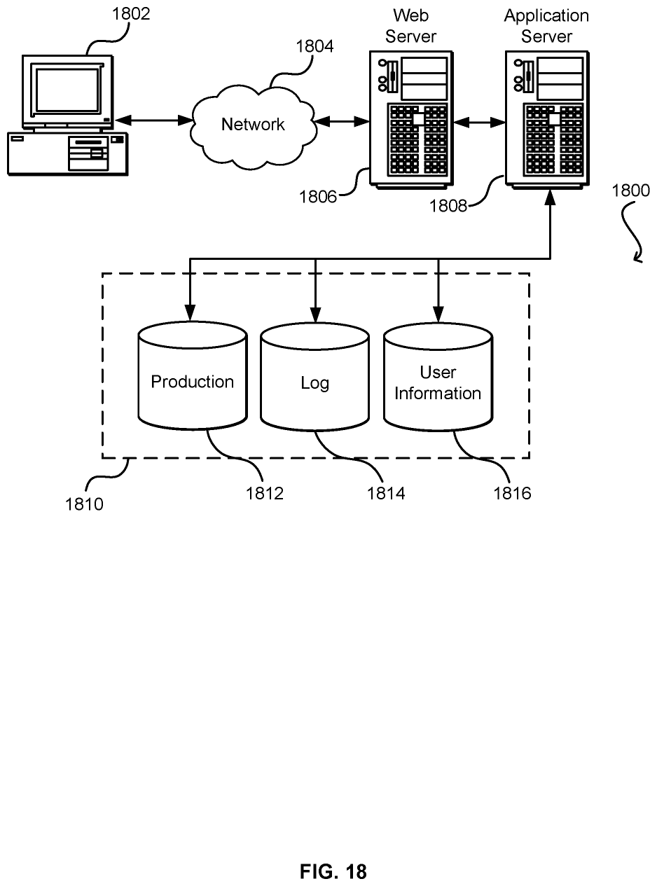

FIG. 18 illustrates aspects of an example environment 1800 for implementing aspects in accordance with various embodiments. As will be appreciated, although a Web-based environment is used for purposes of explanation, different environments may be used, as appropriate, to implement various embodiments. The environment includes an electronic client device 1802, which can include any appropriate device operable to send and receive requests, messages, or information over an appropriate network 1804 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1806 for receiving requests and serving content in response thereto, although for other networks an alternative device serving a similar purpose could be used as would be apparent to one of ordinary skill in the art.

The illustrative environment includes at least one application server 1808 and a data store 1810. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 1802 and the application server 1808, can be handled by the Web server. It should be understood that the Web and application servers are not required and are merely example components, as structured code discussed herein can be executed on any appropriate device or host machine as discussed elsewhere herein.

The data store 1810 can include several separate data tables, databases or other data storage mechanisms and media for storing data relating to a particular aspect. For example, the data store illustrated includes mechanisms for storing production data 1812 and user information 1816, which can be used to serve content for the production side. The data store also is shown to include a mechanism for storing log data 1814, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1810. The data store 1810 is operable, through logic associated therewith, to receive instructions from the application server 1808 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1802. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 18. Thus, the depiction of the system 1800 in FIG. 18 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for substitution preference instruction, the method comprising:
providing for presentation, by a computing system, first user interface data comprising item preference information representing a substitution preference of an item, a first user interface generated with the first user interface data being configured to receive a change command from a user, wherein the first user interface comprises an order summary user interface component, a checkout user interface component, an item detail user interface component, or an order review user interface component;
providing for presentation, by the computing system, second user interface data in accordance with receiving the change command, a second user interface generated with the second user interface data being configured to present an item substitution suggestion including at least a non-substitution suggestion, a similar item substitution suggestion, and a specific item substitution suggestion, and to receive item substitution information;
receiving, by the computing system, the item substitution information via the second user interface;
storing, by the computing system, the item substitution information in a data store; and
providing for presentation, by the computing system, updated second user interface data in accordance with the received item substitution information, an updated second user interface generated with the updated second user interface data being configured to present the item substitution information as item preference information.

2. The computer-implemented method of claim 1, wherein the updated second user interface comprises an order summary user interface component, a checkout user interface component, an item detail user interface component, or an order review user interface component.

3. The computer-implemented method of claim 1, further comprising:
providing for presentation, by the computing system, third user interface data in accordance with receiving notification data, a third user interface generated with the third user interface data being configured to present notification information in accordance with the item substitution information representing a substitution suggestion of the item, and a user preference button configured to receive a user substitution preference for the item; and
providing, by the computing system, for reception of the user substitution preference via the third user interface in accordance with a user interaction with the user preference button; and
storing, by the computing system, the user substitution preference in the data store.

4. The computer-implemented method of claim 3, wherein:
in a first condition wherein the notification data is received within a first time from an order fulfillment event, the third user interface comprises a chat user interface component configured to receive the user substitution preference for the item in real time;
in a second condition wherein the notification data is received within a second time from the order fulfillment event longer than the first time, the third user interface comprises the second user interface; and
the notification data comprises item substitution information associated with the item comprising at least one of an unavailability notification or an available substitute item notification.

5. A computer system, comprising:
a memory configured to store computer-executable instructions; and
one or more processors in communication with the memory and configured to execute the computer-executable instructions to at least:
provide for presentation first user interface data comprising item preference information representing a substitution preference of an item, a first user interface generated with the first user interface data being configured to receive a change command from a user, wherein the first user interface comprises a unified substitution preferences user interface available from a plurality of order building stages;
provide for presentation second user interface data in accordance with receiving the change command, a second user interface generated with the second user interface data being configured to present an item substitution suggestion, and to receive item substitution information;
receive the item substitution information via the second user interface; and
store the item substitution information in a data store.

6. The system of claim 5, wherein:
the item substitution suggestion further comprises at least one of a non-substitution suggestion, a similar item substitution suggestion, or a specific item substitution suggestion; and
the item substitution information comprises at least one of one of a textual instruction, a select-similar instruction, a select-specific instruction, or a non-substitution instruction.

7. The system of claim 6, further configured to:
provide for presentation updated second user interface data in accordance with receiving the item substitution information, an updated second user interface generated with the updated second user interface data being configured to present the item substitution information as item preference information.

8. The system of claim 7, wherein:
the second user interface is further configured to present a user-fillable text field configured to receive the textual instruction;
the computing system stores the textual instruction in the data store; and
the updated second user interface is further configured to present at least a portion of the textual instruction.

9. The system of claim 5, wherein the second user interface is further configured to present attribute information at least in part in association with a user-selectable button, wherein the attribute information is based at least in part on at least one of aggregated textual instruction information stored on the data store, item identifier information, or item type information from an item catalog.

10. The system of claim 5, wherein the plurality of order building stages comprise an order summary user interface component, a checkout user interface component, an item detail user interface component, and an order review user interface component.

11. The system of claim 5, wherein the item substitution suggestion comprises recommended item information based at least in part on an association of a recommended item to the item, using at least one of aggregated item substitution information in the data store or a characteristic item identifier describing the item in an item database.

12. The system of claim 5, wherein the system is further configured to:
receive search query information via a user-fillable text field included in the second user interface, the search query information describing an item substitution preference;
transmit the search query information to a database system;
receive a query result from the database system describing a recommended item; and
present the query result in the second user interface as an updated item substitution suggestion.

13. The system of claim 5, further configured to:
receive notification information in accordance with the substitution preference, describing a substitution suggestion of the item;
provide for presentation third user interface data in accordance with receiving the notification information, a third user interface generated with the third user interface data being configured to present the notification information and a user preference button configured to receive a user substitution preference for the item;
receive, via the third user interface, the user substitution preference in accordance with a user interaction with the user preference button; and
store the user substitution preference in the data store.

14. A computer-readable storage medium storing computer-executable instructions that, when executed by a computer system, configure the computer system to perform operations comprising:
providing for presentation first user interface data comprising item preference information representing a substitution preference of an item, a first user interface generated with the first user interface data being configured to receive a change command from a user;
providing for presentation second user interface data in accordance with receiving the change command, a second user interface generated with the second user interface data being configured to present an item substitution suggestion comprising a non-substitution suggestion and at least one of a similar item substitution suggestion or a specific item substitution suggestion, and to receive item substitution information;
receiving the item substitution information via the second user interface; and
storing the item substitution information in a data store.

15. The computer-readable storage medium of claim 14, wherein the first user interface comprises a unified substitution preferences user interface available from a plurality of order building stages comprising an order summary user interface component, a checkout user interface component, an item detail user interface component, and an order review user interface component.

16. The computer-readable storage medium of claim 14, wherein:
the item substitution suggestion comprises recommended item information received by the computer system; and
the recommended item information is based at least in part on determining a preferred item based at least in part on minimizing a separation function applied to aggregated item substitution information in the data store.

17. The computer-readable storage medium of claim 14, wherein the item substitution suggestion comprises recommended item information comprising a plurality of recommended items, based at least in part on prior item substitution information in the data store.

18. The computer-readable storage medium of claim 14, wherein at least one of the first user interface or the second user interface is further configured to provide for notification information.

19. The computer-readable storage medium of claim 18, wherein:
the notification information comprises at least one of an unavailability notification or an available substitute item notification; and
the notification information is conveyed using at least one of a short message service (SMS) message, an electronic mail message, or an instant message facilitated by a messaging interface generated with messaging interface data provided by the computer system in accordance with receiving the notification information and configured to present notification information.

20. The computer-readable storage medium of claim 19, wherein the messaging interface is further configured to:
present an interactive element configured to receive a user preference;
facilitate two-way communication comprising at least one of images or textual instructions; and
receive user substitution instructions using the interactive element.
